(19) United States
(12) Patent Application Publication
(10) Pub. No.: US 2019/0179178 A1
(43) Pub. Date: Jun. 13, 2019

(54) SUBSTRATE PROCESSING DEVICE

(71) Applicant: SHARP KABUSHIKI KAISHA, Sakai City (JP)

(72) Inventor: KOHSHIROH TANIIKE, Sakai City (JP)

(21) Appl. No.: 16/212,517

(22) Filed: Dec. 6, 2018

(30) Foreign Application Priority Data
Dec. 12, 2017 (JP) 2017-237562

(51) Int. Cl. G02F 1/13; G02F 1/1337

(52) U.S. Cl. CPC G02F 1/1303; G02F 2001/1316; G02F 1/133784

(57) ABSTRACT

A substrate processing device includes a transferring device transferring a liquid crystal substrate, a film forming tank where a thin film is formed on the substrate and including a first supply unit and a second supply unit, a replacement tank where the thin film is replaced with water-based cleaning material, and a cleaning tank where the substrate is cleaned with the water-based cleaning material. The first supply unit supplies the pretreatment material to the alignment treatment surface of the substrate so as to spread in a curtain form in a direction along the alignment treatment surface and perpendicular to the transferring direction and supply the pretreatment material obliquely toward a downstream side in the transferring direction. The second supply unit supplies the pretreatment material to at least a section of the alignment treatment surface.

### CROSS REFERENCE TO RELATED APPLICATION

This application claims priority from Japanese Patent Application No. 2017-237562 filed on Dec. 12, 2017. The entire contents of the priority application are incorporated herein by reference.

### TECHNICAL FIELD

The technology described herein relates to a substrate processing device that performs a cleaning treatment of cleaning a liquid crystal substrate after performing an alignment treatment.

### BACKGROUND

In producing a liquid crystal panel that is a component of a liquid crystal display device, a surface of a liquid crystal glass substrate is coated with a polymer film such as a polyimide film and an alignment treatment such as a rubbing treatment or a polarized ultraviolet ray irradiation treatment is performed.

In the rubbing treatment, minute dust or shavings is created by rubbing the surface of the polymer film. The surface of the substrate is cleaned with ultrasonic waves or high pressure spray using pure water to remove foreign obstacles adhering to the surface of the substrate after the rubbing treatment. However, in the cleaning of the substrate, cleaning unevenness is often occurred.

To effectively remove foreign obstacles and restrict occurrence of the cleaning unevenness on the surface of the substrate, a film forming treatment of forming a film on the surface of the substrate with isopropyl alcohol (IPA) having a hydrophilic property has been widely performed. Specifically, IPA is sprayed on the surface of the substrate to form a thin film of IPA. It is assumed that the cleaning unevenness is reduced by forming an IPA thin film before performing the cleaning with pure water since it is less likely to occur that IPA is replaced with pure water in subsequent processes and moisture remains locally on the surface of the alignment film and partial hydrolysis is undergone. Such a method is described in Unexamined Japanese Patent Application Publication No. 9-33927.

### SUMMARY

IPA has a low boiling point and high volatility. Since a liquid crystal glass substrate has been increased in size recently, it takes longer time for a liquid crystal glass substrate including the IPA thin film to reach a cleaning tank compared to a prior art. Therefore, in the IPA thin film that has been previously formed, a front section of the IPA thin film in a transferring direction may start to be dried. Such unevenness of forming of the film may cause cleaning unevenness and this may adversely affect lowering of quality of a liquid crystal display device.

The technology described herein was made in view of the above circumstances. An object is to provide a substrate processing device in which a liquid crystal substrate that has been subjected to an alignment treatment is transferred from a film forming tank to a subsequent tank while the liquid crystal substrate being entirely covered with a thin film of pretreatment material.

A substrate processing device according to the technology described herein includes a transferring device, a cleaning tank, a film forming tank, and a replacement tank. The transferring device transfers a liquid crystal substrate after being subjected to an alignment treatment in a transferring direction. The liquid crystal substrate is cleaned with water-based cleaning material in the cleaning tank. The film forming tank is arranged on an upstream side of the cleaning tank with respect to the transferring direction and a thin film of pretreatment material is formed on the liquid crystal substrate in the film forming tank. The replacement tank is arranged on the upstream side of the cleaning tank with respect to the transferring direction and the thin film is replaced with the water-based cleaning material in the replacement tank. The film forming tank includes a first supply unit and a second supply unit. The first supply unit supplies the pretreatment material to an alignment treatment surface of the liquid crystal substrate transferred to the film forming tank by the transferring device, the first supply unit supplies the pretreatment material to the alignment treatment surface so as to spread in a curtain form in a direction along the alignment treatment surface and perpendicular to the transferring direction and supply the pretreatment material obliquely toward a downstream side in the transferring direction. The second supply unit is arranged on a downstream side of the first supply unit in the film forming tank with respect to the transferring direction, the second supply unit supplies the pretreatment material to at least a section of the alignment treatment surface.

According to such a configuration, the pretreatment material is supplied to the alignment treatment surface of the liquid crystal substrate in a curtain form with the first supply unit. Therefore, the thin film of the pretreatment material is formed on an entire area of the alignment treatment surface almost evenly with less unevenness. Furthermore, the pretreatment material that is supplied obliquely toward the downstream side can spread effectively and the pretreatment material is less likely to be scattered compared to a configuration in which the pretreatment material is supplied vertically or obliquely toward the upstream side. A flowing (spreading) rate of the pretreatment material that is on the alignment treatment surface is gradually lowered during the transfer to the replacement tank and the flowing (spreading) is finally stopped and the alignment treatment surface is stably covered with the pretreatment material.

In using a large substrate having as the liquid crystal substrate, the front side section of the pretreatment material with respect to the transferring direction is volatilized and a part of the liquid crystal substrate may start to be dried. However, the second supply unit is arranged on the downstream side of the first supply unit with respect to the transferring direction and the additional pretreatment material is supplied to the liquid crystal substrate by the second supply unit. Therefore, the liquid crystal substrate is less likely to be partially dried and the liquid crystal substrate is transferred to the replacement tank while being effectively covered with the pretreatment material. Therefore, flowing or spread unevenness is less likely to be caused in the subsequent replacement treatment step and quality of the liquid crystal display device is less likely to be lowered. The second supply unit may be one or multiple second supply units may be arranged in the transferring direction.

The technology described herein provides a substrate processing device in which a liquid crystal substrate that has been subjected to an alignment treatment is transferred from a film forming tank to a subsequent tank while the liquid crystal substrate being entirely covered with a thin film of pretreatment material.

### BRIEF DESCRIPTION OF THE DRAWINGS

FIG. 1 is a schematic view of a substrate processing device according to a first embodiment.

FIG. 2 is a schematic perspective view illustrating a curtain type shower and a pipe type shower ejecting IPA to an IPA liquid crystal substrate.

FIG. 3 is a bottom view of the pipe type shower.

FIG. 4 is a schematic view illustrating the pipe type shower ejecting IPA to the liquid crystal substrate.

FIG. 5 is a bottom view of a pipe type shower according to a second embodiment.

FIG. 6 is a schematic view illustrating the pipe type shower ejecting IPA to the liquid crystal substrate.

FIG. 7 is a bottom view of a pipe type shower according to a third embodiment.

FIG. 8 is a schematic view illustrating the pipe type shower ejecting IPA to the liquid crystal substrate.

FIG. 9 is a bottom view of a pipe type shower according to a forth embodiment.

FIG. 10 is a schematic view illustrating the pipe type shower ejecting IPA to the liquid crystal substrate.

### DETAILED DESCRIPTION

### First Embodiment

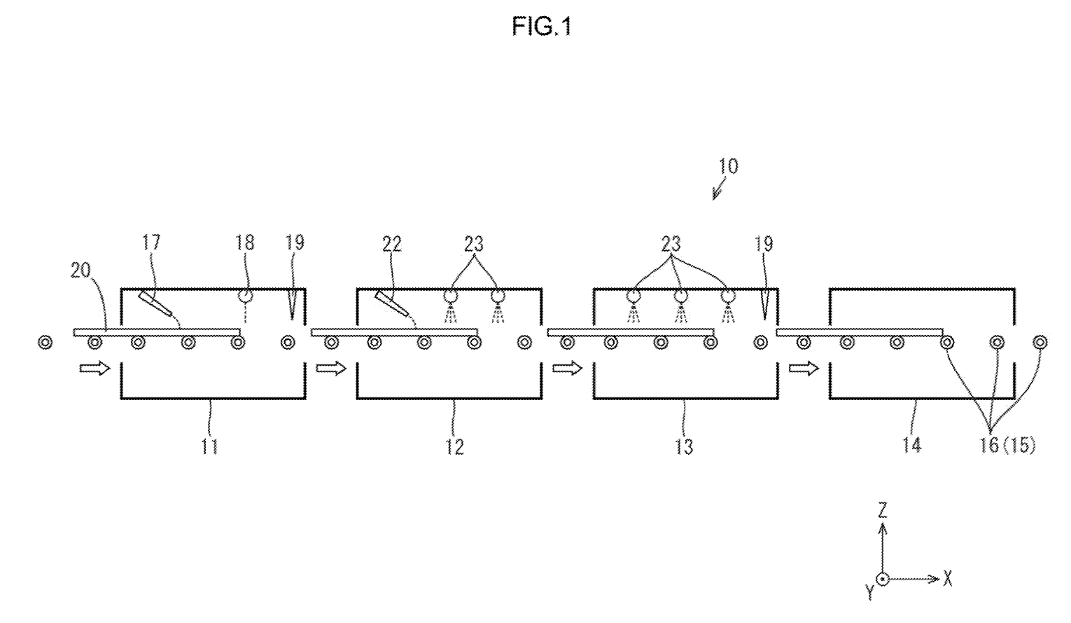

A first embodiment of the present technology will be described with reference to FIGS. 1 to 4.

As illustrated in FIG. 1, a substrate processing device 10 according to this embodiment includes treatment tanks. The substrate processing device 10 cleans foreign obstacles such as minute dust or shavings adhering on a surface of a liquid crystal substrate 20. Such foreign obstacles are generated by an alignment treatment such as rubbing a polyimide film.

In the following description, an X-axis direction in FIG. 1 is defined as a transferring direction of the liquid crystal substrate 20 (a front-rear direction), an Y-axis direction that is perpendicular to a paper surface is defined as a right-left direction (a width direction of the liquid crystal substrate 20 that is transferred), and a Z-axis direction is defined as a vertical direction. In FIG. 1, a left side is an upstream side in the transferring direction and a right side is a downstream side in the transferring direction. In the substrate processing device 10, the liquid crystal substrate 20 is introduced into a tank from the upstream side in the transferring direction while an alignment treatment surface 20A (a surface where a thin film is to be formed) facing upward and the liquid crystal substrate 20 being in a horizontal state. The liquid crystal substrate 20 is transferred from the upstream side to the downstream side in the transferring direction by a transferring device 15 while a long side direction thereof being along the X-axis direction and a short side direction thereof being along the Y-axis direction.

As illustrated in FIG. 1, the substrate processing device 10 includes four treatment tanks including a film forming tank 11, a replacement tank 12, a cleaning tank 13, and a drying tank 14 in this order from the upstream side (the left side). The substrate processing device 10 includes the transferring device 15. The transferring device 15 includes transferring rollers 16 that transfer the liquid crystal substrate 20 with a driving source, which is not illustrated, in the transferring direction (the X-axis direction). The liquid crystal substrate 20 is intermittently supported by the transferring rollers 16 that are contacted with a plate surface (a lower surface) of the liquid crystal substrate 20 opposite from an alignment treatment surface 20A (a surface where a thin film is to be formed). Thus, the liquid crystal substrate 20 is transferred sequentially through each of the treatment tanks in the transferring direction by the transferring device 15 and is subjected to respective treatment in each treatment tank.

In this embodiment, the liquid crystal substrate 20 has a size of G4.5 or G6 and the transferring speed is 2000 mm/min. to 3000 mm/min.

In the film forming tank 11, after the alignment treatment with the rubbing method and before the cleaning with water, a thin film of isopropyl alcohol (IPA 21) (an example of pretreatment material) is formed on the liquid crystal substrate 20. In an upper section of the film forming tank 11, a curtain type shower 17 (an example of a first supply unit) and a pipe type shower 18 (an example of a second supply unit) are arranged. The curtain type shower 17 and the pipe type shower 18 are arranged above the liquid crystal substrate 20 that is introduced into the tank. The curtain type shower 17 is arranged on the upstream side and the pipe type shower 18 is arranged on the downstream side in the transferring direction. IPA 21 is supplied to the alignment treatment surface 20A of the liquid crystal substrate 20 by the curtain type shower 17 and the pipe type shower 18.

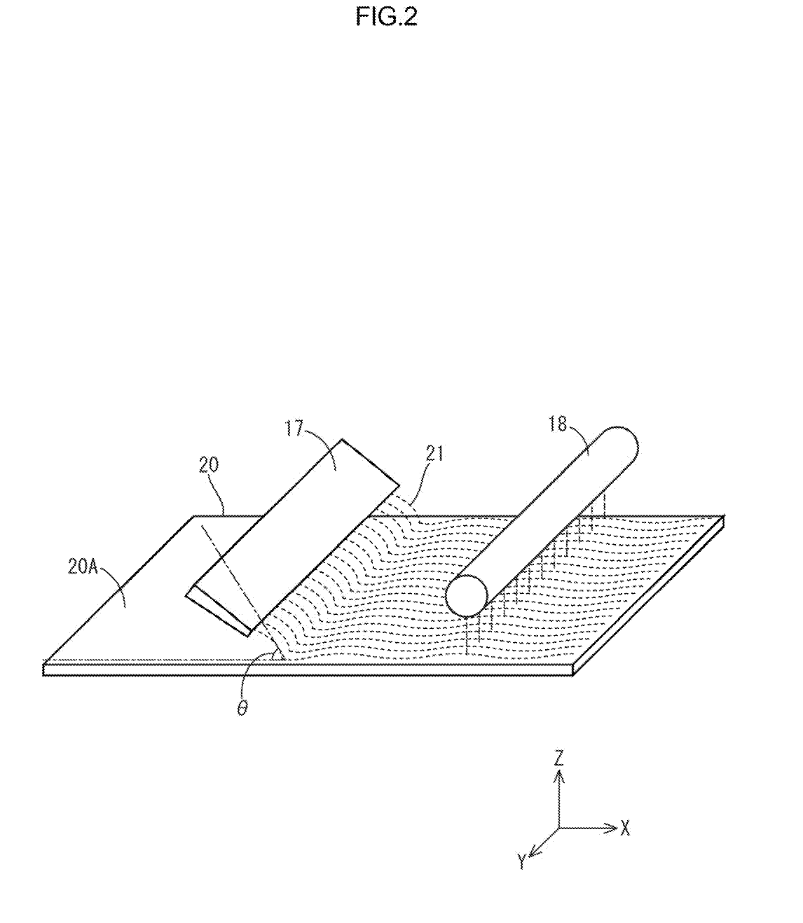

The curtain type shower 17 is connected to a pipe extending from an IPA storing tank, which is not illustrated, and extends in a direction that is along the alignment treatment surface 20A (an X-Y plane surface) of the liquid crystal substrate 20 and perpendicular to the transferring direction (the Y-axis direction). The curtain type shower 17 has thin and long slits, which are not illustrated, on a lower edge surface and IPA 21 is ejected through the slits in a curtain form as illustrated in FIG. 2. The slits are formed such that IPA 21 is ejected to the alignment treatment surface 20A (the X-Y surface) of the liquid crystal substrate 20 at a certain angle θ toward the downstream side in the transferring direction (toward the right side in FIG. 1). Namely, the slits are formed such that IPA 21 is ejected therethrough in a liquid curtain form. The alignment treatment surface 20A of the liquid crystal substrate 20 is covered with an IPA thin film that is formed from IPA 21 ejected obliquely from the curtain type shower 17. The IPA thin film is formed with less unevenness and almost evenly in an entire area of the alignment treatment surface 20A. The angle θ is preferably within a range from 30° to 80°.

The IPA thin film disposed on the liquid crystal substrate 20 may be volatilized gradually from an edge portion of the liquid crystal substrate 20 near a front side with respect to the transferring direction, particularly from a corner portion, and a part of the thin film may be removed from the liquid crystal substrate 20 before being transferred to the replacement tank 12.

However, in the substrate processing device 10 of this embodiment, the pipe type shower 18 is arranged in the downstream side of the curtain type shower 17. IPA 21 is ejected to the liquid crystal substrate 20 again by the pipe type shower 18 with a time difference after the IPA ejection by the curtain type shower 17 and before the liquid crystal substrate 20 is discharged from the film forming tank 11.

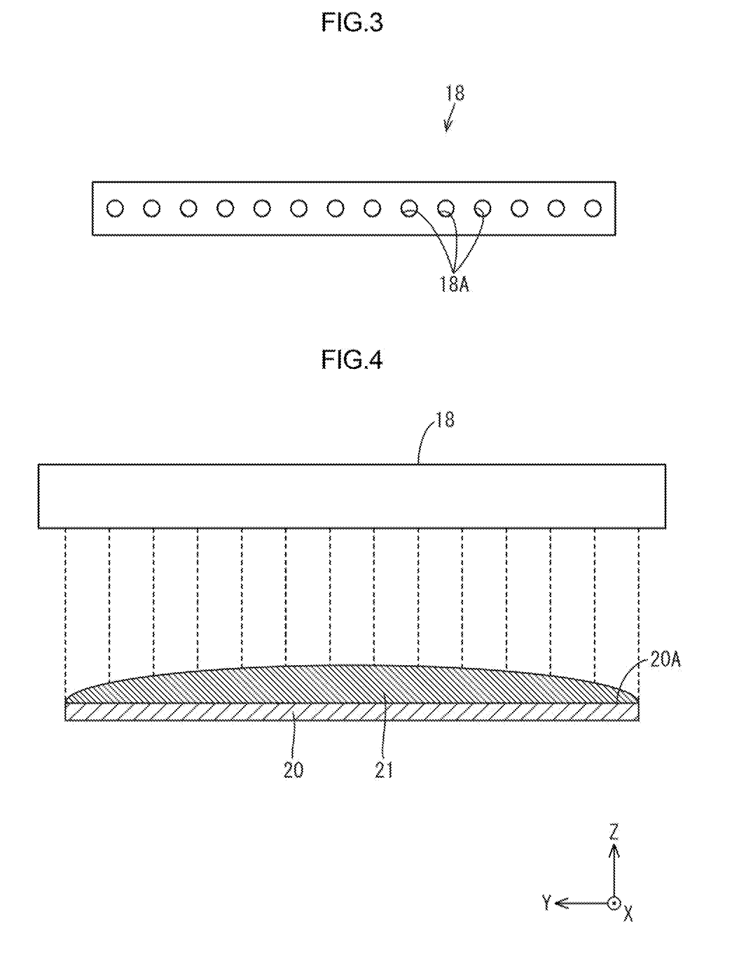

The pipe type shower 18 is made of metal and connected to a pipe extending from the IPA storing tank, which is not illustrated. The pipe type shower 18 has a thin elongated cylindrical shape extending along the alignment treatment surface 20A (the X-Y surface) of the liquid crystal substrate 20 and extending in a direction (the Y-axis direction) perpendicular to the transferring direction. As illustrated in FIG. 3, the pipe type shower 18 includes ejecting holes 18A on a surface (a lower surface) opposite the liquid crystal substrate 20. The ejecting holes 18A are arranged in a line at an equal interval. IPA 21 is ejected through the ejecting holes 18A vertically to the liquid crystal substrate 20. The ejecting holes 18A have a same hole diameter. Specifically, each of the ejecting holes 18A has a hole diameter from 0.5 mm φ to 1.0 mm φ and a distance between the adjacent ejecting holes 18A is from 10 mm to 15 mm. The ejecting amount is from 5 l/min. to 20 l/min. The IPA thin film is formed on the alignment treatment surface 20A of the liquid crystal substrate 20 entirely over a width direction of the liquid crystal substrate 20 just before being discharged from the film forming tank 11.

FIG. 4 illustrates a schematic view of the liquid crystal substrate 20 to which IPA 21 is ejected from the pipe type shower 18 to the liquid crystal substrate 20 (the alignment treatment surface 20A). IPA 21 is ejected through the ejecting holes 18A of the pipe type shower 18 and the amount of IPA 21 ejected from each ejecting hole 18A is same. IPA 21 supplied to the liquid crystal substrate 20 may flow toward the side edges of the liquid crystal substrate 20. According to the influence of the surface tension of IPA 21, IPA 21 on the liquid crystal substrate 20 has a film thickness that is great at a middle section thereof with respect to a width direction (the Y-axis direction) and is smaller as is closer the side edges as illustrated in FIG. 4.

It is preferable to arrange the pipe type shower 18 away from an IPA supply section of the curtain type shower 17 on the alignment treatment surface 20A by a distance of 30 cm to 90 cm. If the pipe type shower 18 is too close to the curtain type shower 17, the flowing of IPA 21 ejected from the curtain type shower 17 may not be stopped when IPA 21 is ejected from the pipe type shower 18. Therefore, IPA 21 ejected from the pipe type shower 18 is likely to be influenced by the flowing of IPA ejected from the curtain type shower 17 and is likely to flow. If the pipe type shower 18 is too far away from the curtain type shower 17, a greater section of the IPA thin film that has been formed with the curtain type shower 17 may be removed and therefore, an amount of IPA 21 that is necessary for the pipe type shower 18 to be additionally ejected is increased and it is wasteful.

Extra IPA on the liquid crystal substrate 20 is removed with an air knife 19 mounted near a discharge port of the film forming tank 11. As illustrated in FIG. 1, the liquid crystal substrate 20 is transferred from the film forming tank 11 to the replacement tank 12 while the entire upper surface (the alignment treatment surface 20A) of the liquid crystal substrate 20 being covered with the thin film of IPA 21.

The replacement tank 12 includes a curtain type shower 22 that is similar to that mounted in the film forming tank 11. The curtain type shower 22 is arranged in an upper section of the replacement tank 12. Namely, the curtain type shower 22 is arranged on the upstream side in the transferring direction and above the liquid crystal substrate 20 that is introduced into the tank by the transferring device 15. Pure water (an example of water-based cleaning material) for replacement is ejected from the curtain type shower 22 to the liquid crystal substrate 20. The replacement tank 12 includes nozzle type showers 23 made of resin on a downstream side of the curtain type shower 22. Each of the nozzle type showers 23 has nozzles through which pure water for replacement is supplied to the liquid crystal substrate 20.

The nozzle type shower 23 extends along the alignment treatment surface 20A of the liquid crystal substrate 20 and extends straightly in a direction (the Y-axis direction) perpendicular to the transferring direction. Two to four nozzle type showers 23 (two nozzle type showers 23 in this embodiment) are arranged in the transferring direction. IPA 21 is replaced with pure water supplied to the surface (the alignment treatment surface 20A) of the liquid crystal substrate 20 and the entire surface of the substrate is covered with pure water.

The liquid crystal substrate 20 that has been subjected to the pure water replacement treatment in the replacement tank 12 is transferred to the cleaning tank 13 by the transferring device 15. The cleaning tank 13 includes the nozzle type showers 23 that are similar to those mounted in the replacement tank 12. The nozzle type showers 23 are arranged in an upper section of the cleaning tank 13 and are arranged above the liquid crystal substrate 20 that is introduced into the cleaning tank 13 by the transferring device 15. The nozzle type showers 23 (three nozzle type showers 23 in this embodiment) are arranged in the transferring direction. The liquid crystal substrate 20 is subjected to a high pressure cleaning treatment with pure water ejected from the nozzle type showers 23 such that foreign obstacles on the surface of the liquid crystal substrate 20 are removed.

The cleaning tank 13 includes the air knife 19 near a discharge port thereof. Liquid is removed from the liquid crystal substrate 20 with the air knife 19 and the liquid crystal substrate 20 is transferred to the drying tank 14 by the transferring device 15. In the drying tank 14, extra moisture that remains on the liquid crystal substrate 20 and has not been removed completely with the air knife is removed completely. The liquid crystal substrate 20 is subjected to a high temperature drying treatment and discharged from the drying tank 14 and discharged from the substrate processing device 10.

Next, operations and advantageous effects of the substrate processing device 10 of the present embodiment will be described.

The substrate processing device 10 according to this embodiment includes the transferring device 15 that transfers the liquid crystal substrate 20 in the transferring direction, the cleaning tank 13 in which the liquid crystal substrate 20 is subjected to the water-based cleaning material and cleaned, the film forming tank 11 and the replacement tank 12 that are arranged on the upstream side of the cleaning tank 13 with respect to the transferring direction. The thin film of IPA 21 is formed on the liquid crystal substrate 20 in the film forming tank 11 and the thin film is replaced with the water-based cleaning material in the replacement tank 12. The film forming tank 11 includes the curtain type shower 17 that ejects IPA 21 to the alignment treatment surface 20A of the liquid crystal substrate 20 transferred by the transferring device 15. The curtain type shower 17 supplies IPA 21 in a curtain form so as to spread in a direction along the alignment treatment surface 20A and perpendicular to the transferring direction. IPA 21 is ejected obliquely toward the downstream side in the transferring direction. The film forming tank 11 includes the pipe type shower 18 that supplies IPA 21 to the alignment treatment surface 20A on the downstream side of the curtain type shower 17 with respect to the transferring direction.

According to such a configuration, IPA 21 is supplied to the alignment treatment surface 20A of the liquid crystal substrate 20 in a curtain form with the curtain type shower 17. Therefore, the thin film of IPA 21 is formed on an entire area of the alignment treatment surface 20A almost evenly with less unevenness. Furthermore, IPA 21 that is ejected from the curtain type shower 17 obliquely toward the downstream side can spread effectively and IPA 21 is less likely to be scattered compared to a configuration in which IPA 21 is ejected vertically or obliquely toward the upstream side. A flowing (spreading) rate of IPA 21 that is on the alignment treatment surface is gradually lowered during the transfer to the replacement tank 12 and the flowing (spreading) is finally stopped and the alignment treatment surface 20A is stably covered with IPA 21.

In using a large substrate having a G4 size or greater as the liquid crystal substrate 20, the front side section of the IPA thin film with respect to the transferring direction is volatilized and a part of the liquid crystal substrate 20 may start to be dried. However, the pipe type shower 18 is arranged on the downstream side of the curtain type shower 17 with respect to the transferring direction and the additional IPA 21 is ejected to the liquid crystal substrate 20 by the pipe type shower 18. Therefore, the liquid crystal substrate 20 is less likely to be partially dried and the liquid crystal substrate 20 is transferred to the replacement tank 12 while being effectively covered with IPA 21.

Accordingly, in the replacement tank 12, pure water ejected from the curtain type shower 22 spreads over IPA 21 evenly and without having unevenness and the IPA film is replaced with the pure water. Therefore, unevenness is less likely to be caused in cleaning the liquid crystal substrate 20 with pure water in the cleaning tank 13 and quality of the liquid crystal display device is less likely to be lowered.

In the substrate processing device 10, the curtain type shower 17 is arranged such that IPA 21 is ejected at a certain angle θ with respect to the alignment treatment surface 20A (the X-Y plan surface) of the liquid crystal substrate 20 toward the downstream side (the right side in FIG. 1) in the transferring direction. Namely, IPA 21 is ejected obliquely in a liquid curtain form. Therefore, IPA 21 is less likely to be scattered compared to a configuration in which the liquid curtain form is vertical or inclined obliquely toward the upstream side.

The pipe type shower 18 has the ejecting holes 18A through which IPA 21 is ejected to the liquid crystal substrate 20. The ejecting holes 18A are arranged at an equal interval in the direction along the alignment treatment surface 20A and the perpendicular to the transferring direction.

According to such a configuration, IPA 21 is supplied evenly over an entire area extending in a width direction (the Y-axis direction) of the liquid crystal substrate 20.

The pipe type shower 18 that has a smaller ejecting amount and a simpler configuration than the curtain type shower 17 is used as a second IPA supply unit such that the IPA thin film is less likely to be partially dried with a simple structure as a whole.

Furthermore, in the pipe type shower 18 with a small ejecting amount, IPA 21 is ejected vertically to the alignment treatment surface 20A such that the supplied IPA 21 is less likely to flow on the alignment treatment surface 20A.

### Second Embodiment

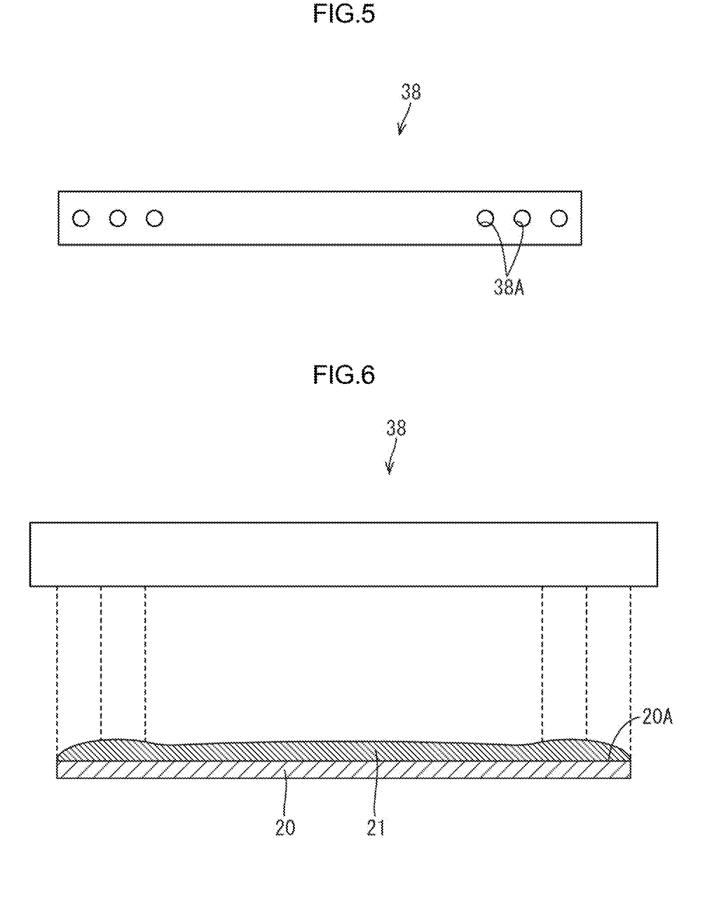

A second embodiment of the present technology will be described with reference to FIGS. 5 and 6. The second embodiment includes a pipe type shower 38 that differs from that of the first embodiment. Other configurations are same as those of the first embodiment and will not be described.

The pipe type shower 38 included in the film forming tank of a substrate processing device according to this embodiment differs from that of the first embodiment. As illustrated in FIG. 5, the pipe type shower 38 has ejecting holes 38A locally at two end sections with respect to a direction (the Y-axis direction) perpendicular to the transferring direction. The IPA 21 thin film formed on the liquid crystal substrate 20 tends to be thinner at the two end sections with respect to the width direction (the Y-axis direction) of the liquid crystal substrate 20 and to be relatively thick in a middle section thereof. The pipe type shower 38 has the ejecting holes 38A at the two end sections thereof that correspond to the two end sections to the IPA 21 thin film and has no ejecting hole at the middle section thereof that corresponds to the middle section of the IPA 21 thin film. Namely, the ejecting amount of IPA ejected from the pipe type shower 38 has a certain distribution with respect to the width direction.

As illustrated in FIG. 6, the liquid crystal substrate 20 to which IPA 21 is ejected with such a pipe type shower 38 has a film thickness greater at the two end sections thereof with respect to the width direction than the film thickness of the middle section.

According to the configuration of the second embodiment, IPA 21 is additionally supplied to only the thin sections of the liquid crystal substrate 20, that are the two end sections of the liquid crystal substrate 20 with respect to the direction along the alignment treatment surface 20A and perpendicular to the transferring direction. Therefore, IPA 21 can be saved.

### Third Embodiment

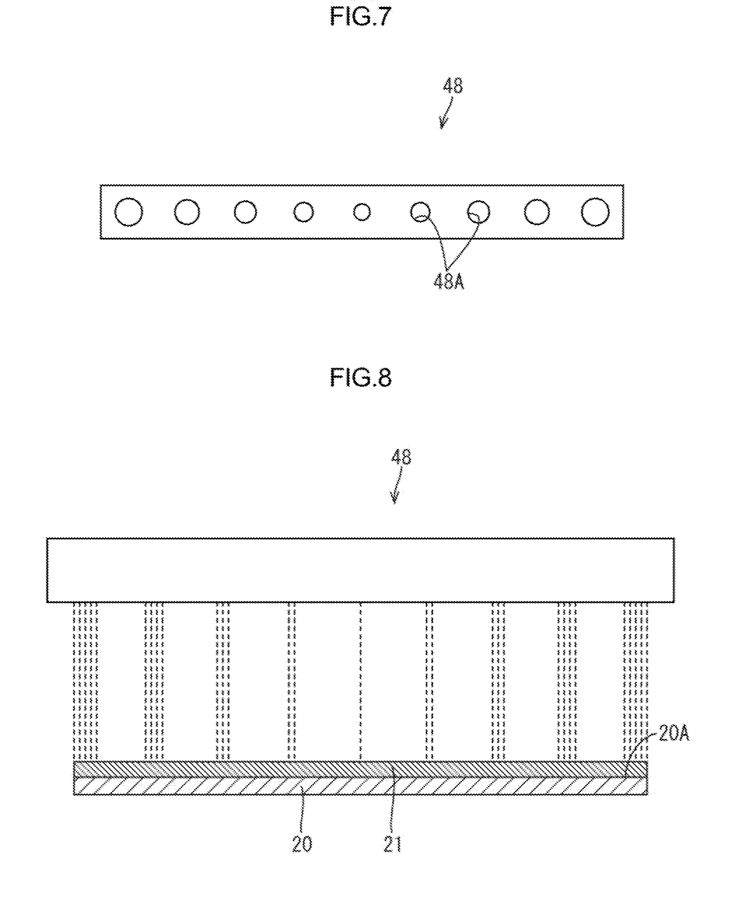

A third embodiment of the present technology will be described with reference to FIGS. 7 and 8. The third embodiment includes a pipe type shower 48 that differs from that of the first embodiment.

As illustrated in FIG. 7, the pipe type shower 48 has ejecting holes 48A having different hole diameters. The hole diameter of the ejecting holes 48A decreases as is closer to the middle section of the pipe type shower 48 with respect to the direction (the Y-axis direction) perpendicular to the transferring direction and increases as is closer to the two end sections thereof. Namely, the ejecting amount of IPA ejected from the pipe type shower 48 has a certain distribution with respect to the width direction. The ejecting holes 48A are arranged at an equal interval.

A part of the IPA thin film that is formed over an entire area of the alignment treatment surface 20A with the curtain type shower 17 may be volatilized and removed, and the removed section can be supplied with IPA 21 again by the pipe type shower 48 of this embodiment. Furthermore, IPA 21 is additionally supplied with a certain distribution with respect to the width direction such that the amount of IPA ejected from the pipe type shower 48 is increased at the thin sections (the two end sections with respect to the direction perpendicular to the transferring direction) of the liquid crystal substrate 20. Therefore, as illustrated in FIG. 8, the IPA thin film is formed with a substantially same thickness over the entire area with respect to the width direction and the liquid crystal substrate 20 having such an IPA thin film is transferred to a first cleaning tank.

### Fourth Embodiment

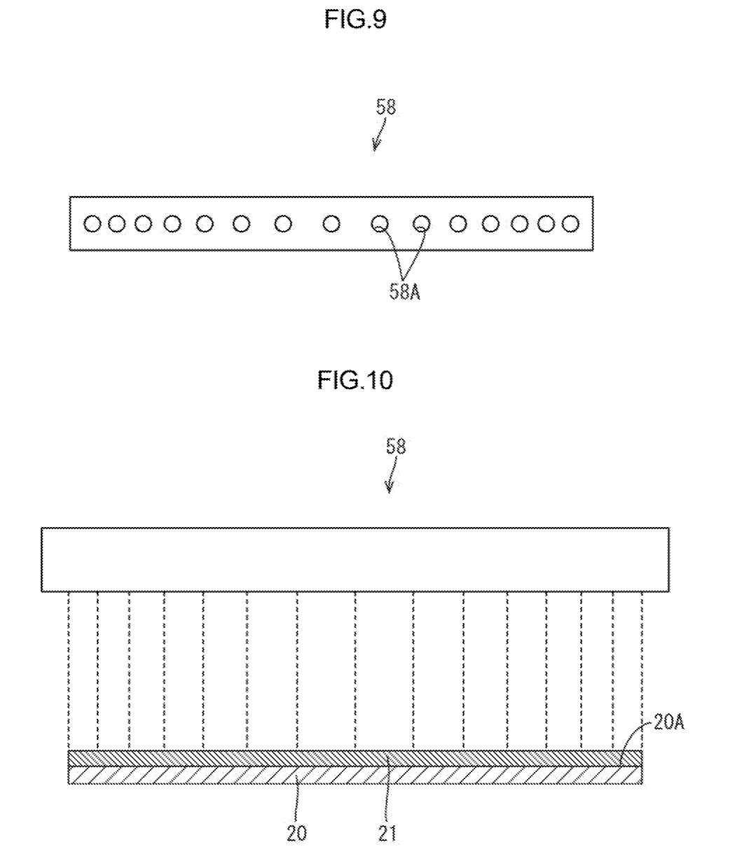

A fourth embodiment of the present technology will be described with reference to FIGS. 9 and 10. The fourth embodiment includes a pipe type shower 58 that differs from that of the first embodiment.

As illustrated in FIG. 9, the pipe type shower 58 of this embodiment has ejecting holes 58A. The pipe type shower 58 has the ejecting holes 58A at a low density in a middle section thereof and at a higher density at two end sections thereof. Namely, the ejecting amount of IPA ejected from the pipe type shower 58 has a certain distribution with respect to the width direction. The ejecting holes 58A have a same hole diameter.

Similarly to the third embodiment, a part of the IPA thin film that is formed over an entire area of the alignment treatment surface 20A with the curtain type shower 17 may be volatilized and removed, and the removed section can be supplied with IPA 21 again by the pipe type shower 58 of this embodiment. Therefore, as illustrated in FIG. 10, the IPA thin film is formed with a substantially same thickness over the entire area with respect to the width direction and the liquid crystal substrate 20 having such an IPA thin film is transferred to a first cleaning tank.

### Other Embodiments

The technology described herein is not limited to the embodiments described in the above sections and the drawings. For example, the following embodiments may be included in a technical scope.

(1) The pretreatment material and the water-based cleaning material may not be limited to the above described examples and other materials may be used.

(2) Instead of the pipe type shower, any other types of supply unit such as metal nozzle type shower having an IPA resistance property may be used as the second supply unit.

(3) The pipe type shower (the second supply unit) may be formed in a V-shape such that a middle section thereof is disposed on the downstream side in the transferring direction and two end sections thereof are disposed on the upstream side.

(4) The film forming tank may include two or more than two pipe type showers (the second supply units).

(5) The substrate processing device may include two or more cleaning tanks.

(6) IPA (the pretreatment material) may be supplied from the pipe type shower (the second supply unit) with any other methods such as spraying.

(7) One tank may be divided into cleaning tank sections to provide cleaning tanks.

(8) The cleaning tank may include a ultrasonic shower, bubble jetting, cavitation jetting, high-pressure spray shower, and a two-fluid type according to a desired effect of removal of foreign obstacles.

1. A substrate processing device comprising:
a transferring device transferring a liquid crystal substrate after being subjected to an alignment treatment in a transferring direction;
a cleaning tank in which the liquid crystal substrate is cleaned with water-based cleaning material;
a film forming tank arranged on an upstream side of the cleaning tank with respect to the transferring direction, the film forming tank in which a thin film of pretreatment material is formed on the liquid crystal substrate; and
a replacement tank arranged on the upstream side of the cleaning tank with respect to the transferring direction, the replacement tank in which the thin film is replaced with the water-based cleaning material, wherein
the film forming tank includes
a first supply unit supplying the pretreatment material to an alignment treatment surface of the liquid crystal substrate transferred to the film forming tank by the transferring device, the first supply unit supplying the pretreatment material to the alignment treatment surface so as to spread in a curtain form in a direction along the alignment treatment surface and perpendicular to the transferring direction and supply the pretreatment material obliquely toward a downstream side in the transferring direction, and
a second supply unit arranged on a downstream side of the first supply unit in the film forming tank with respect to the transferring direction, the second supply unit supplying the pretreatment material to at least a section of the alignment treatment surface.

2. The substrate processing device according to claim 1, wherein
the second supply unit has supply holes through which the pretreatment material is supplied to the liquid crystal substrate, and
the supply holes are arranged at an equal interval in a direction along the alignment treatment surface and perpendicular to the transferring direction.

3. The substrate processing device according to claim 1, wherein
the second supply unit has supply holes through which the pretreatment material is supplied to the liquid crystal substrate, and
the supply holes are arranged locally in two end sections of the second supply unit with respect to a direction along the alignment treatment surface and perpendicular to the transferring direction.

4. The substrate processing device according to claim 1, wherein
the second supply unit has supply holes through which the pretreatment material is supplied to the liquid crystal substrate, and
the supply holes are arranged such that some of the supply holes formed in two end sections of the second supply unit with respect to a direction along the alignment treatment surface and perpendicular to the transferring direction have a hole diameter greater than that of one of the supply holes formed in a middle section of the second supply unit.

5. The substrate processing device according to claim 1, wherein
the second supply unit has supply holes through which the pretreatment material is supplied to the liquid crystal substrate, and
the supply holes are arranged such that some of the supply holes formed in two end sections of the second supply unit with respect to a direction along the alignment treatment surface and perpendicular to the transferring direction are arranged at a density higher than that of some of the supply holes formed in a middle section of the second supply unit.

6. The substrate processing device according to claim 2, wherein the second supply unit is a pipe type shower having the supply holes.

7. The substrate processing device according to claim 1, wherein the second supply unit is configured to supply the pretreatment material vertically to the liquid crystal substrate.
